(19) United States
(12) Patent Application Publication
(10) Pub. No.: US 2020/0076024 A1
(43) Pub. Date: Mar. 5, 2020

(54) ACCUMULATOR ASSEMBLY

(71) Applicant: Mahle International GmbH, Stuttgart (DE)

(72) Inventors: Thomas Kalmbach, Stuttgart (DE); Alireza Mirsadraee, Ludwigsburg (DE); Oleksandr Pavlov, Herrenberg (DE); Mario Wallisch, Aichtal (DE); Achim Wiebelt, Neustadt (DE)

(21) Appl. No.: 16/552,768

(22) Filed: Aug. 27, 2019

(30) Foreign Application Priority Data
Aug. 28, 2018 (DE) 10 2018 214 528.8

(51) Int. Cl. H01M 10/6555; H01M 10/613

(52) U.S. Cl. CPC H01M 10/6555; H01M 10/613

(57) ABSTRACT

An accumulator assembly for a hybrid or electric vehicle may include a plurality of battery cells respectively having mutually opposite bearing faces. The battery cells may be stacked in a stacking direction facing one another with the bearing faces to form a battery block. The assembly may also include a cooling device which may include a plurality of cooling elements disposed between neighbouring battery cells of the plurality of battery cells and braced in the stacking direction. A respective cooling element may have two compression plates which bear in a heat-transmitting manner on a bearing face of each of the neighbouring battery cells. The two compression plates may delimit a compression space therebetween. The compression space may be compressible such that an expansion of the neighbouring battery cells in the stacking direction is absorbable at least via an elastic deformation of the two compression plates into the compression space.

### CROSS-REFERENCE TO RELATED APPLICATIONS

This application claims priority to German Patent Application No. DE 10 2018 214 528.8, filed on Aug. 28, 2018, the contents of which are hereby incorporated by reference in its entirety.

### TECHNICAL FIELD

The invention relates to an accumulator assembly for a hybrid or electric vehicle.

### BACKGROUND

An accumulator assembly, or a traction battery, respectively, for a hybrid or electric vehicle usually has a plurality of individual battery cells which are combined so as to form a battery module. The individual battery cells in the respective battery module herein are held together by a tensioning device. In the case of pouch cells, the latter by virtue of their unstable shape have to be additionally held together by a suitable mounting or by suitable components, respectively. Furthermore, the individual battery cells in the battery module have to be cooled, wherein an improved heat dissipation between the individual battery cells bearing on one another is in particular pursued.

For example, in the case of pouch cells, auxiliary frames from plastics material can be utilized for establishing in a form-fitting manner and holding the individual battery cells in the respective battery module. For cooling the battery cells herein, ducts which can be passed through by a flow of coolant can be configured in the auxiliary frame. However, the auxiliary frame for establishing and for holding the individual battery cells is often used in the respective battery module, and cooling is performed by cooling structures which are thermally linked to the cell dissipators of the battery cells. Alternatively, U-shaped steel-sheet plates having an auxiliary frame from plastics material can be used for establishing in each case two battery cells on one another, wherein the respective battery cells established on one another are subsequently combined so as to form the respective battery module by way of tensioning brackets. The steel-sheet plates herein are utilized for dissipating heat from the battery cells to a coolant plate that is passed through by a flow of coolant.

In most instances, solutions of this type disadvantageously have an increased requirement in terms of space. Furthermore, the battery cells can often only be cooled from one cell side and, on account thereof, not be sufficiently cooled. Moreover, the equalization of tolerances and the sealing of the battery module can also be problematic.

### SUMMARY

It is therefore the object of the invention to specify an improved or at least alternative embodiment for accumulator assemblies of the generic type in which the disadvantages described are at least in part overcome.

Said object is achieved according to the invention by the subject matter of the independent claim(s). Advantageous embodiments are the subject matter of the dependent claim(s).

The present invention is based on the general concept of substituting complex construction element for holding and cooling in an accumulator assembly for a hybrid or electric vehicle with simple and multifunctional structural components. The accumulator assembly herein has a plurality of battery cells having mutually opposite bearing faces, wherein the battery cells in the stacking direction are stacked so as to face one another by way of the bearing faces and so as to form a battery block. The accumulator assembly furthermore has a cooling device having a plurality of cooling elements which are disposed between the neighbouring battery cells and conjointly with the latter are braced in the stacking direction. According to the invention, the respective cooling element has two at least in regions mutually spaced-apart compression plates which bear in a heat-transmitting manner on the bearing faces of the respective neighbouring battery cells and at least in regions delimit a compression space which is disposed between the compression plates and is compressible in the stacking direction. An expansion of the respective neighbouring battery cells in the stacking direction herein can be absorbed at least by the elastic deformation of the compression plates into the compression space.

In the accumulator assembly according to the invention, the heat generated in the battery cells can be dissipated through the respective cooling element. To this end, the compression plates can be formed from a heat-conducting material such as metal, for example. The cooling element herein by way of the compression plates bears in a planar and heat-transmitting manner on the bearing faces of the battery cells, and said cooling element can compensate the expansion, or an increase in thickness, respectively of the respective neighbouring battery cells. In the event of an expansion of the respective neighbouring battery cells, the compression plates can deform into the compression space such that the compression plates continue to bear in a planar and heat-transmitting manner on the bearing faces. The compression plates herein are elastically deformed such that the compression plates in the event of a contraction, or a decrease in thickness, respectively, of the respective neighbouring battery cells follow the respective bearing faces and continue to bear in a planar and heat-transmitting manner on said bearing faces. Consequently, on account of the cooling elements according to the invention, the individual battery cells can be effectively cooled independently of the variation in thickness of said battery cells as a result of the charge status or of aging. The compression space of the cooling element can be closed. For example, the compression plates can be fixed perpendicular to the stacking direction on each other at their opposite sides.

It can advantageously be provided that the respective cooling element is a metallic profile. The profile is preferably produced from aluminium and preferably by an extrusion press method or by an extrusion method, or is produced as a steel-sheet bent part. The metallic profile, in particular from aluminium, enables an effective dissipation of heat from the respective neighbouring battery cells. Moreover, the metallic profile can be produced in a time-saving and cost-saving manner by the extrusion press method or by the extrusion method such that the production costs and the production complexity can overall be reduced.

In one advantageous refinement of the solution according to the invention it is provided that the compression space at least in regions is filled with a compression element. The compression element herein can absorb the elastic deformation of the compression plates into the compression space. The compression element can advantageously be formed from a foam-type material or from a foam-type material composite. The foam-type material is preferably a polyurethane foam, and the foam-type material composite is preferably a polyurethane foam. The compression element herein can have a plurality of pores which can be passed through by a flow of a cooling fluid, for example. The pores of the compression element herein can be configured in such a manner that said pores can continue to be passed through by a flow of the cooling fluid even in the event of a compression of the compression element as a result of an expansion of the battery cells in the stacking direction. On account thereof, the compression plates in the compression space can be passed around by a flow of the cooling fluid and the dissipation of heat from the battery cells bearing on the compression plates can be intensified on account thereof. In order for a flow of the cooling fluid passing through the pores of the compression element to be optimized, the pores can be open, for example and be aligned in the flow direction of the cooling fluid. In order for the rigidity of the cooling element to be increased, the compression element can alternatively or additionally have at least one spring element that is disposed between the compression plates.

In one advantageous embodiment of the accumulator assembly the respective cooling element at least on one side can have a cell-holding collar. The cell-holding collar in the stacking direction can project from the respective compression plates at least on one side. In this instance, at least one of the respective neighbouring battery cells can at least in regions bear on the cell-holding collar and, on account thereof, can be established transversely to the stacking direction in the battery block. The cell-holding collar in the stacking direction can advantageously project from both sides and, on account thereof, can establish the two neighbouring battery cells transversely to the stacking direction. In this advantageous way the battery cells, and in particular pouch cells, in the battery block can be established transversely to the stacking direction by the respective cooling element such that a conventionally required mounting for the battery cells can be dispensed with and the overall construction of the accumulator assembly is simplified. The cell-holding collar in relation to the compression plates can at least in regions advantageously have an angle that deviates from 90° in order to reduce the risk of damage to the battery cells, and in particular to the pouch cells, when assembling. Alternatively or additionally, the cooling element at least on one side can have a peripheral support collar which in the stacking direction projects from both sides of the compression plates. The battery block can be supported in a housing by way of the support collar, for example.

It can advantageously be provided that the cell-holding collar and/or the support collar by way of a spring unit that is resilient transversely to the stacking direction are/is connected to the respective compression plates. A variation in the length of the cooling element transversely to the stacking direction herein can be compensated as a result of a deformation of the compression plates in the stacking direction. In particular, the battery cells herein are only insignificantly influenced by the cell-holding collar and, on account thereof, are additionally treated with care, independently of the variation in thickness of said battery cells in the stacking direction. The resilient spring unit can be formed, for example, by a corrugated connection region which adjoins the cell-holding collar and/or the support collar and/or at least one of the compression plates in an integral manner.

In the case of one advantageous refinement of the solution according to the invention it is provided that the cooling device has a cooling plate which can be passed through by a flow of a cooling fluid and is disposed on one side of the battery block. The respective cooling element in this instance can be established in a heat-transmitting manner, preferably a materially integral manner, at least on one side of the cooling plate. On account thereof, the heat generated in the battery cells by way of the compression plates of the cooling element can be dissipated to the cooling plate and at the latter be discharged to the cooling fluid. The cooling fluid can be a liquid. The compression plates and the cooling plate herein can be composed of a heat-conducting material, for example of metal and in particular of aluminium, so as to optimize the dissipation of heat from the battery cells to the cooling fluid. Alternatively, it can be provided that the cooling device has a fluid distributor and/or a fluid collector which can be passed through by a flow of cooling fluid and are/is in each case disposed on one side of the battery block. The respective cooling element herein can be passed through by a flow of a cooling fluid and is fluidically connected to the fluid distributor and/or to the fluid collector of the cooling device. The compression space of the cooling element can be closed such that a cooling fluid can flow through the compression space. The cooling fluid can be a liquid. In this advantageous way, the heat generated in the battery cells can be dissipated by way of the compression plates directly to the cooling fluid, and the dissipation of heat from the battery cells to the cooling fluid can be intensified.

Summarizing, the battery cells in the accumulator assembly according to the invention can be effectively cooled on both sides at the beginning as well as at the end of the life cycle independently of the variation in thickness of said battery cells by virtue of the charge status. Furthermore, the cooling element of the accumulator assembly according to the invention unifies thermal as well as mechanical functions and said cooling element can be embodied and produced in a simplified manner as a metallic profile. Additionally, the individual battery cells can also be established transversely to the stacking direction by the cooling element such that additional, conventionally required mountings are dispensed with. On account thereof, the overall construction of the battery block can advantageously be simplified.

Further important features and advantages of the invention are derived from the dependent claims, from the drawings, and from the associated description of the figures by means of the drawings.

It is understood that the features mentioned above and the features yet to be discussed below may be used not only in the respectively specified combination but also in other combinations or individually without departing from the scope of the present invention.

Preferred exemplary embodiments of the invention are illustrated in the drawings and will be explained in more detail in the description hereunder, wherein the same reference signs refer to identical or similar or functionally equivalent components.

### BRIEF DESCRIPTION OF THE DRAWINGS

In the schematic drawings:

FIG. 1 shows a sectional view of an accumulator assembly according to the invention;

FIG. 2 shows a view of a cooling element in the accumulator assembly according to the invention;

FIG. 3 shows a partial view of the cooling element from FIG. 2 in the accumulator assembly according to the invention; and

FIG. 4 shows a partial view of a cooling element of an alternative design embodiment in the accumulator assembly according to the invention.

### DETAILED DESCRIPTION

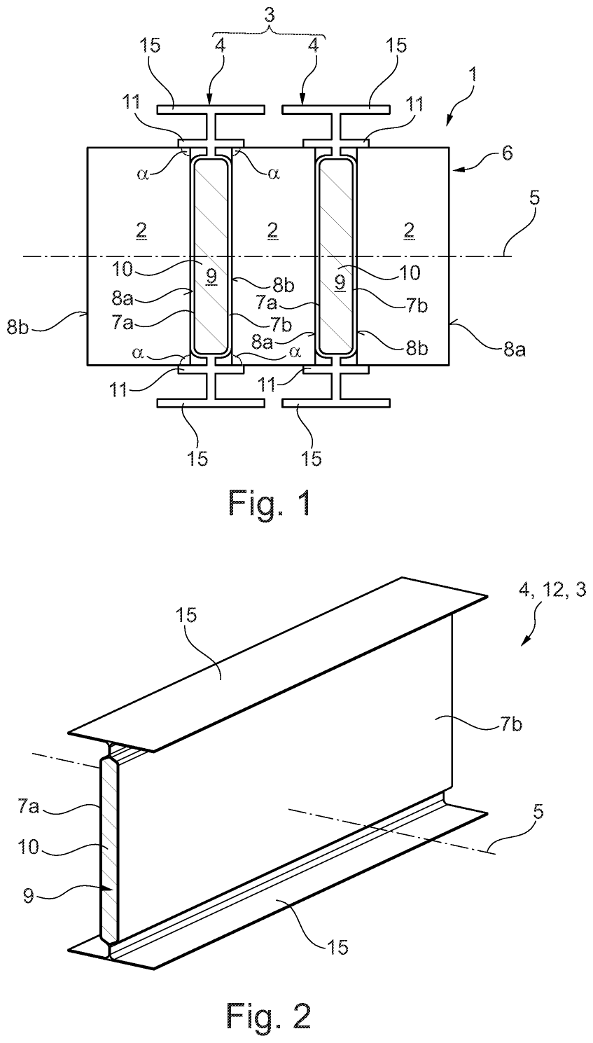

FIG. 1 shows a sectional view of an accumulator assembly 1 according to the invention for a hybrid or electric vehicle. The accumulator assembly 1 herein has a plurality of battery cells 2 and a cooling device 3 having a plurality of cooling elements 4. The respective cooling elements 4 herein are disposed between the battery cells 2 and conjointly with the latter braced in the stacking direction 5 so as to form a battery block 6. The respective cooling element 4 herein has two mutually spaced-apart compression plates 7a and 7b which bear in a heat-transmitting manner on the bearing faces 8a and 8b of the respective neighbouring battery cells 2. The two compression plates 7a and 7b in regions herein delimit a compression space 9 that is compressible in the stacking direction 5. Only part of the accumulator assembly 1 is shown in FIG. 1. It goes without saying that the accumulator assembly 1 can also have further battery cells 2 and further cooling elements 4, as well as other construction elements such as, for example, a cooling plate that can be passed through by a flow of a cooling fluid, or a tensioning device.

An expansion, or an increase in thickness, respectively, of the respective neighbouring battery cells 2 in the stacking direction 5 in the accumulator assembly 1 can be absorbed by the elastic deformation of the compression plates 7a and 7b into the compression space 9. A contraction, or a decrease in thickness, respectively, of the respective neighbouring battery cells 2 can also be compensated by the compression plates 7a and 7b on account of the elastic deformation of the compression plates 7a and 7b. Consequently, the compression plates 7a and 7b in the event of a variation in thickness of the battery cells 2 bear on the bearing faces 8a and 8b and can effectively dissipate the heat generated in the battery cells. Summarizing, the individual battery cells 2 can be effectively cooled at the beginning as well as at the end of the life cycle independently of the variation in thickness of said battery cells by virtue of the charge status. The respective compression plates 7a and 7b are expediently composed of a heat-conducting material and can be of metal, for example, and in particular of aluminium.

The compression space 9 in this exemplary embodiment is completely filled with a compression element 10. The compression element 10 absorbs the elastic deformation of the compression plates 7a and 7b into the compression space 9, and said compression element 10 can be formed from a foam-type material, for example, or from a foam-type material composite. The foam-type material is preferably a polyurethane foam, and the foam-type material composite is preferably from a polyurethane foam. In order for the rigidity of the cooling element 4 to be increased, the compression element 10 can additionally have at least one spring element that is disposed between the two compression plates 7a and 7b. The compression element 10 can furthermore have a plurality of pores which can be passed through by a flow of a cooling fluid, for example. On account thereof, the compression plates 7a and 7b in the compression space 9 can be passed around by a flow of the cooling fluid and the dissipation of heat from the battery cells 2 bearing on the compression plates 7a and 7b can be intensified on account thereof.

The respective cooling element 4 moreover on both sides has a cell-holding collar 11 that projects on both sides. The cell-holding collar 11 herein in the stacking direction 5 projects from the compression plates 7a and 7b and establishes the respective neighbouring battery cells 2 transversely to the stacking direction 5. In this advantageous way, the battery cells 2, and in particular pouch cells, can be held in the battery block 6, and a conventionally required mounting for the battery cells 2 is dispensed with. The cell-holding collar 11 in this exemplary embodiment in relation to the compression plates 7a and 7b has an angle α equal to 90°. However, the angle α can also deviate from 90° in order to reduce a risk of damage to the battery cells 2, and in particular to the pouch cells, in the assembling. The cooling element 4 furthermore on both sides has a peripheral support collar 15 that projects on both sides in the stacking direction 5. The battery block 6 can be supported in a housing by way of the support collar 15, for example.

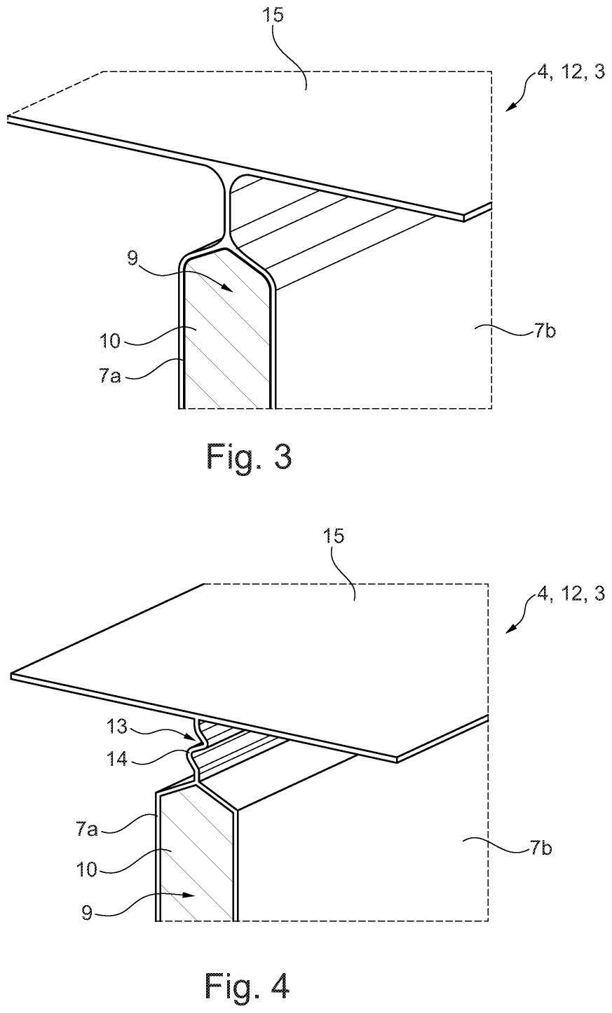

FIG. 2 shows a view, and FIG. 3 shows an enlarged partial view, of the cooling element 4 in the accumulator assembly 1 according to the invention. The respective cooling element 4 in this exemplary embodiment is a metallic profile 12. The profile 12 is preferably produced from aluminium and preferably by an extrusion press method or by another extrusion method, or is produced as a steel-sheet bent part. The metallic profile 12 improves a dissipation of heat from the respective neighbouring battery cells 2. Deviating from the cooling element 4 in FIG. 1, the cooling element 4 here does not have a cell-holding collar 11. The cooling element 4 here otherwise corresponds to the cooling element 4 illustrated in FIG. 1.

FIG. 4 shows a partial view of the cooling element 4 of the alternative design embodiment. Deviating from the cooling element 4 in FIG. 2 and FIG. 3, the support collar 15 here is connected to the respective compression plates 7a and 7b by way of a resilient spring unit 13. The spring unit 13 herein is formed by a corrugated connection region 14 which adjoins the support collar 15 and the compression plates 7a and 7b in an integral manner. The spring unit 13 herein is resilient transversely to the stacking direction 5 such that a variation in the length of the cooling element 4 transversely to the stacking direction 5 as a result of a deformation of the compression plates 7a and 7b in the stacking direction 5 can be compensated. The cooling element 4 here otherwise corresponds to the cooling element 4 shown in FIG. 2 and FIG. 3.

Summarizing, the battery cells 2 in the accumulator assembly 1 according to the invention are cooled on both sides. Furthermore, the dissipation of heat remains effective at the beginning as well as at the end of the life cycle of the battery cells 2, independently of the variation in thickness of the battery cells 2 by virtue of the charge status. Moreover, the cooling element 4 unifies thermal as well as mechanical functions and said cooling element 4 can be produced in a simplified manner as the metallic profile 12. A conventionally required mounting is advantageously also dispensed with since the individual battery cells 2 are established transversely to the stacking direction 5 by the cooling element 4. Overall, the overall construction of the battery block 6 and of the accumulator assembly 1 can advantageously be simplified.

1. An accumulator assembly for a hybrid or electric vehicle, comprising:
a plurality of battery cells respectively having mutually opposite bearing faces;
the battery cells stacked in a stacking direction facing one another with the bearing faces to form a battery block;
a cooling device including a plurality of cooling elements disposed between neighbouring battery cells of the plurality of battery cells and, conjointly with the neighbouring battery cells, braced in the stacking direction;
a respective cooling element of the plurality of cooling elements having two, at least in regions, mutually spaced-apart compression plates which bear in a heat-transmitting manner on a bearing faces of each of the neighbouring battery cells and, the two compression plates, at least in regions, delimiting a compression space therebetween, the compression space compressible in the stacking direction such that an expansion of the neighbouring battery cells in the stacking direction is absorbable at least via an elastic deformation of the two compression plates into the compression space.

2. The accumulator assembly according to claim 1, wherein the respective cooling element is a metallic profile.

3. The accumulator assembly according to claim 1, wherein the compression space, at least in regions, is filled with a compression element structured and arranged to absorb the elastic deformation of the two compression plates into the compression space.

4. The accumulator assembly according to claim 3, wherein at least one of:
the compression element is composed of a foam-type material; and
the compression element includes at least one spring element disposed between the two compression plates.

5. The accumulator assembly according to claim 1, wherein:
the respective cooling element, at least on one side, includes a cell-holding collar which, in the stacking direction, projects from the two compression plates at least on one side; and
at least one of the neighbouring battery cells, at least in regions, bears on the cell-holding collar and is secured transversely to the stacking direction in the battery block.

6. The accumulator assembly according to claim 5, wherein an angle between the cell-holding collar and the two compression plates, at least in regions, deviates from 90°.

7. The accumulator assembly according to claim 5, wherein:
at least one of i) the cell-holding collar and ii) a support collar, is connected to the two compression plates such that a variation in a length of the respective cooling element transversely to the stacking direction is compensable via a deformation of the two compression plates in the stacking direction; and
the support collar is disposed peripherally and at least on one side of the respective cooling element, and projects in the stacking direction from the two compression plates on both sides via a spring unit that is resilient transversely to the stacking direction.

8. The accumulator assembly according to claim 7, wherein the resilient spring unit is structured as a corrugated connection region adjoining at least one of the cell-holding collar, the support collar, and at least one of the two compression plates, in an integral manner.

9. The accumulator assembly according to claim 1, wherein:
the cooling device includes a cooling plate through which a flow of a cooling fluid is passable, the cooling plate disposed on one side of the battery block; and
the respective cooling element is established in a heat-transmitting manner at least on one side of the cooling plate.

10. The accumulator assembly according to claim 1, wherein:
the cooling device includes at least one of a fluid distributor and a fluid collector through which a flow of cooling fluid is passable, the at least one of the fluid distributor and the fluid collector disposed on one side of the battery block; and
a flow of a cooling fluid is passable through the respective cooling element and the respective cooling element is fluidically connected to the at least one of the fluid distributor and the fluid collector of the cooling device.

11. The accumulator assembly according to claim 2, wherein the metallic profile is composed of aluminium.

12. The accumulator assembly according to claim 2, wherein the metallic profile is a steel-sheet bent part.

13. The accumulator assembly according to claim 3, wherein the compression element is composed of a polyurethane foam.

14. The accumulator assembly according to claim 3, wherein the compression element includes at least one spring element disposed between the two compression plates.

15. An accumulator assembly for a hybrid or electric vehicle, comprising:
a plurality of battery cells stacked along a stacking direction defining a battery block, each of the plurality of battery cells having a plurality of bearing faces disposed opposite one another and facing in the stacking direction;
a cooling device including a plurality of cooling elements disposed between neighbouring battery cells of the plurality of battery cells and braced in the stacking direction conjointly with the neighbouring battery cells; and
a respective cooling element of the plurality of cooling elements having two compression plates respectively bearing in a heat-transmitting manner on a bearing face of one of the neighbouring battery cells, the two compression plates, at least in regions, disposed spaced-apart from one another delimiting a compression space therebetween, the compression space compressible in the stacking direction such that an expansion of the neighbouring battery cells in the stacking direction is absorbable at least via an elastic deformation of the two compression plates into the compression space.

16. The accumulator assembly according to claim 15, wherein the respective cooling element includes at least one support collar disposed peripherally on at least one side of the respective cooling element and extending in the stacking direction from both sides of the respective cooling element.

17. The accumulator assembly according to claim 16, wherein the at least one support collar is connected to the two compression plates via a spring unit which is resilient in a direction extending transversely to the stacking direction.

18. The accumulator assembly according to claim 17, wherein the spring unit is defined by a corrugated connection region adjoining the at least one support collar and at least one of the two compression plates in an integral manner.

19. The accumulator assembly according to claim 15, wherein the respective cooling element includes:
two support collars projecting transversely from at least one of the two compression plates, the two support collars disposed on opposing ends of the respective cooling element such that the compression space is disposed between the two support collars; and
two cell-holding collars projecting transversely from at least one of the two compression plates, the two cell-holding collars disposed on opposing ends of the respective cooling element between the compression space and one of the two support collars.

20. An accumulator assembly for a hybrid or electric vehicle, comprising:
a plurality of battery cells stacked along a stacking direction defining a battery block, each of the plurality of battery cells having a plurality of bearing faces disposed opposite one another and facing in the stacking direction;
a cooling device including a plurality of cooling elements disposed between neighbouring battery cells of the plurality of battery cells and braced in the stacking direction conjointly with the neighbouring battery cells;
a respective cooling element of the plurality of cooling elements having two compression plates respectively bearing in a heat-transmitting manner on a bearing face of one of the neighbouring battery cells, the two compression plates, at least in regions, disposed spaced-apart from one another delimiting a compression space therebetween, the compression space compressible in the stacking direction such that an expansion of the neighbouring battery cells in the stacking direction is absorbable at least via an elastic deformation of the two compression plates into the compression space;
wherein the respective cooling element includes two cell-holding collars projecting transversely from at least one of the two compression plates, the two cell-holding collars disposed on opposing ends of the respective cooling element such that the compression space is disposed between the two cell-holding collars; and
wherein the two cell-holding collars contact opposing ends of the neighbouring battery cells securing the neighbouring battery cells within the battery block in a direction extending transversely to the stacking direction.
